(19) United States
(12) Patent Application Publication
(10) Pub. No.: US 2026/0037763 A1
(43) Pub. Date: Feb. 5, 2026

(54) DYNAMIC AND RESPONSIVE PHYSICAL COMMUNICATION CONTENT AND LAYOUT GENERATION

(71) Applicant: Capital One Services, LLC, McLean, VA (US)

(72) Inventors: Bryan TAMAYO, Allen, TX (US); Megan DEEDS, Celina, TX (US)

(21) Appl. No.: 18/791,531

(22) Filed: Aug. 1, 2024

(51) Int. Cl. G06K 15/02; G06F 40/117

(52) U.S. Cl. CPC G06K 15/1836; G06F 40/117; G06K 15/1805

(57) ABSTRACT

In some implementations, a device may obtain interaction data relating to a recipient of an initial physical communication item. The initial physical communication item may use an initial content configuration having one or more initial content modules arranged in an initial layout. The device may determine, based on the interaction data, a new content configuration having one of: a different layout for arranging the one or more initial content modules, or one or more new content modules and a new layout for arranging the one or more new content modules. The device may generate an electronic document with a responsive rendering of the new content configuration. The device may cause printing of a subsequent physical communication item using the electronic document.

### BACKGROUND

Content personalization techniques involve tailoring content to individual users or specific segments of users based on their preferences, behavior, demographics, and/or other relevant data. Among other techniques, content personalization may be achieved via user profiling to gather and analyze user data to understand user characteristics, preferences, and behavior, collaborative filtering to identify patterns of interest by collecting preferences or behavior data from a group of users and recommend items based on similarities in user preferences or behavior, and/or content-based filtering to recommend items to users based on the similarity between the content of the items and the profile or historical behavior of the user.

### SUMMARY

Some implementations described herein relate to a system for dynamic and responsive physical communication content and layout generation. The system may include one or more memories and one or more processors communicatively coupled to the one or more memories. The one or more processors may be configured to obtain interaction data relating to a plurality of recipients of physical communication items. The interaction data may include first interaction data indicating interactions of the plurality of recipients with the physical communication items, and second interaction data indicating interactions of the plurality of recipients in one or more non-physical-communication channels. The one or more processors may be configured to determine respective content configurations for the plurality of recipients. The respective content configurations may include a first content configuration, for a first recipient of the plurality of recipients, having one or more first content modules and a first layout for arranging the one or more first content modules based on the interaction data that relates to the first recipient, and a second content configuration, for a second recipient of the plurality of recipients, having one or more second content modules and a second layout for arranging the one or more second content modules based on the interaction data that relates to the second recipient. The one or more processors may be configured to generate a plurality of electronic documents including a first electronic document with a responsive rendering of the first content configuration and a second electronic document with a responsive rendering of the second content configuration. The one or more processors may be configured to cause variable data printing of a plurality of physical communication items using the plurality of electronic documents.

Some implementations described herein relate to a method of dynamic and responsive physical communication content and layout generation. The method may include obtaining interaction data relating to a recipient of an initial physical communication item. The interaction data may include first interaction data indicating an interaction of the recipient with the initial physical communication item, and second interaction data indicating an interaction of the recipient in a non-physical-communication channel. The initial physical communication item may use an initial content configuration having one or more initial content modules arranged in an initial layout. The method may include determining, based on the interaction data, a new content configuration having one of: a different layout for arranging the one or more initial content modules, or one or more new content modules and a new layout for arranging the one or more new content modules. The method may include generating an electronic document with a responsive rendering of the new content configuration. The method may include causing printing of a subsequent physical communication item using the electronic document.

Some implementations described herein relate to a non-transitory computer-readable medium that stores a set of instructions for dynamic and responsive physical communication content and layout generation. The set of instructions, when executed by one or more processors of a device, may cause the device to obtain interaction data relating to a recipient of an initial physical communication item. The interaction data may indicate an interaction of the recipient with the initial physical communication item. The initial physical communication item may use an initial content configuration having one or more initial content modules arranged in an initial layout. The set of instructions, when executed by one or more processors of the device, may cause the device to generate an electronic document with a responsive rendering of a new content configuration, where the new content configuration has one of: a different layout for arranging the one or more initial content modules, or one or more new content modules and a new layout for arranging the one or more new content modules. The set of instructions, when executed by one or more processors of the device, may cause the device to cause printing of a subsequent physical communication item using the electronic document.

### BRIEF DESCRIPTION OF THE DRAWINGS

FIGS. 1A-1C are diagrams of an example associated with dynamic and responsive physical communication content and layout generation, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with dynamic and responsive physical communication content and layout generation, in accordance with some embodiments of the present disclosure.

FIG. 4 is a flowchart of an example process associated with dynamic and responsive physical communication content and layout generation, in accordance with some embodiments of the present disclosure.

### DETAILED DESCRIPTION

The following detailed description of example implementations refers to the accompanying drawings. The same reference numbers in different drawings may identify the same or similar elements.

An entity (e.g., a car dealership or other merchant) may communicate with users (e.g., customers and/or potential customers) via numerous communication channels that include both digital channels (e.g., an email channel and/or a web channel) and physical channels (e.g., a postal mail channel). Communications tend to receive higher user-engagement when the communications use dynamic content and/or layouts, which can be personalized for different users based on their historical interaction behavior. Due to the generally dynamic nature of digital channels, dynamic content and/or layouts can be easily utilized in communications that use digital channels.

However, physical channels, such as postal mail, generally lack adaptability and are not easily used with dynamic content and/or layouts. For example, postal mail may use variable data printing (VDP) to introduce basic variable content into a pre-defined, mostly-static template (e.g., a custom recipient's name may be printed at a designated location in the template), but VDP may lack techniques for generating fully dynamic and responsive content and/or layouts. In general, the printing of a single postal mail item may use minimal computing resources (e.g., memory resources, processor resources, or the like) and printer resources. However, commonly, the entity may be engaged in operations that call for the transmission of hundreds, thousands, or even millions of postal mail items, which in the aggregate place a significant burden on computing resources and printer resources. A level of personalization used for a postal mail item may play a role in whether a recipient engages with the mail item (e.g., reads the mail item, accesses a link printed on the mail item, scans a quick response (QR) code printed on the mail item, or the like). Thus, by printing postal mail items that lack dynamic content and/or layouts, significant computing resources and printer resources may be expended in an inefficient manner.

Some implementations described herein enable dynamic content and layouts for physical communication items (e.g., postal mail items). In some implementations, a device may determine the content and layout for a physical communication item based on interaction data relating to a recipient of the physical communication item. For example, the interaction data may relate to interactions of the recipient with previous physical communication items as well as interactions of the recipient in non-physical-communication channels (e.g., an email channel, a web channel, or the like). In some implementations, the device may determine the content and layout using a machine learning model trained to identify, based on the interaction data, particular content that is to be arranged in a particular layout to achieve a probability of engagement by the recipient. Thus, physical communication items using dynamic content and layouts provide a more efficient utilization of computing resources and printer resources (e.g., recipients may engage with such physical communication items at higher rates).

The device may generate an electronic document based on the determined content and layout. The electronic document may be configured to responsively render the content in accordance with the layout. The responsive rendering for the electronic document may use dynamic document object model (DOM) manipulation of the electronic document. For example, the electronic document may be a hypertext markup language (HTML) document that includes client-side dynamic scripting (e.g., JavaScript) configured for DOM manipulation. The responsive rendering for the electronic document allows robust dynamic content to be added to the physical communication item in a fast and efficient manner suitable for extensive VDP runs that otherwise could not be achieved using restrictive, pre-defined templates. The device may generate electronic documents for multiple recipients in real time as physical communication items are being printed, or may generate a batch of electronic documents for multiple recipients that are stored for a subsequent printing run.

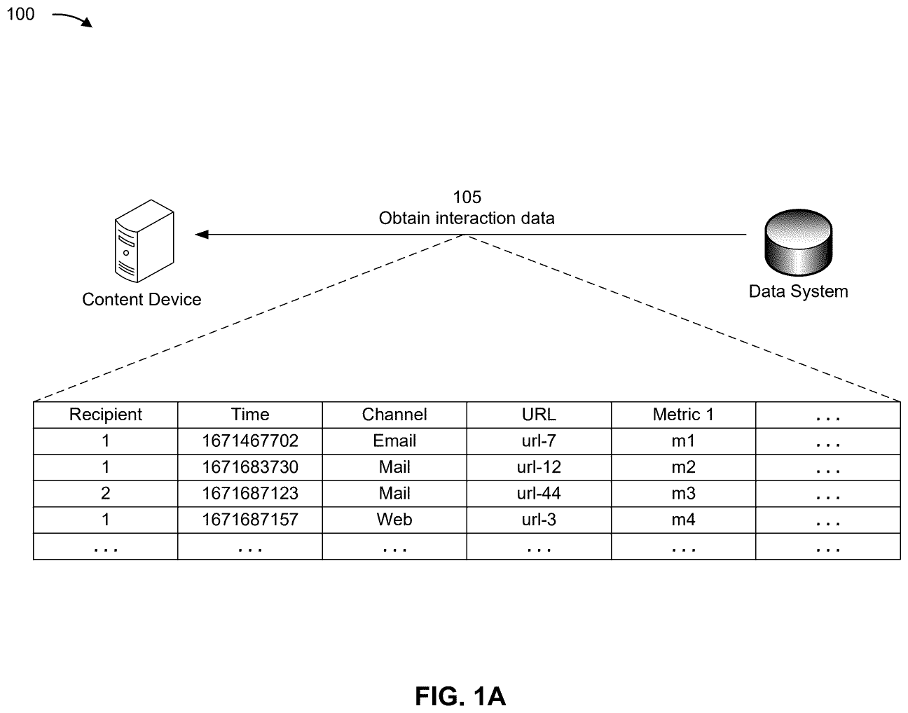

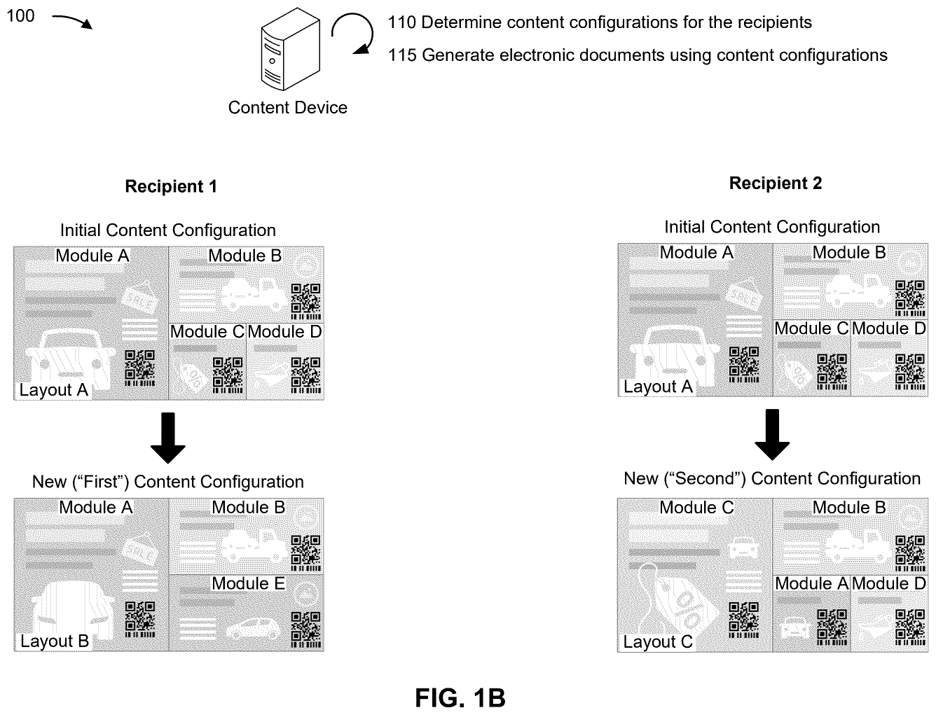

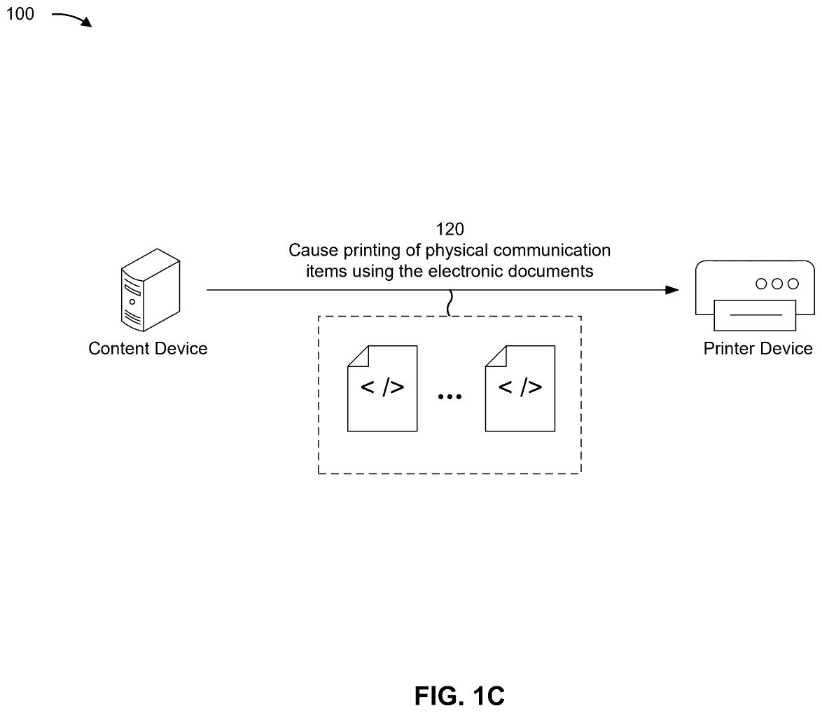

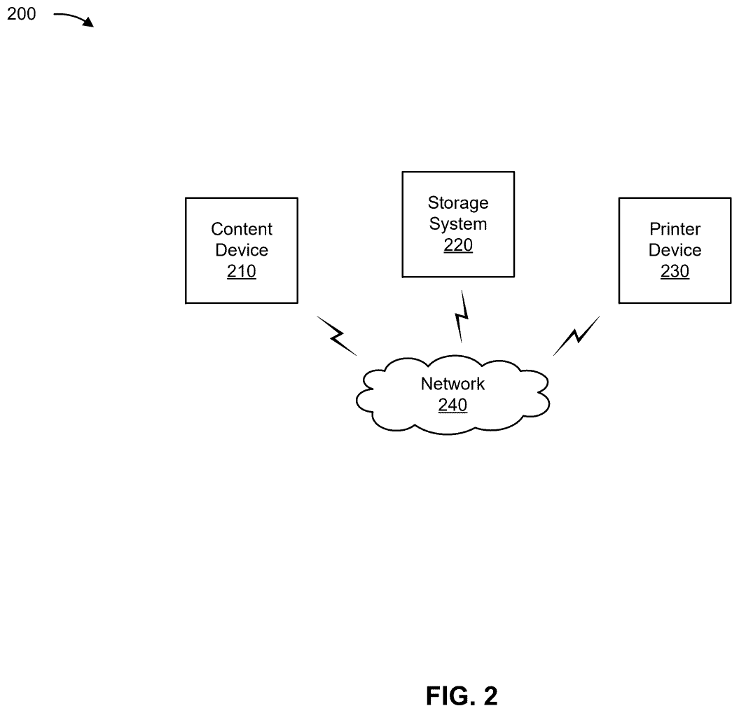

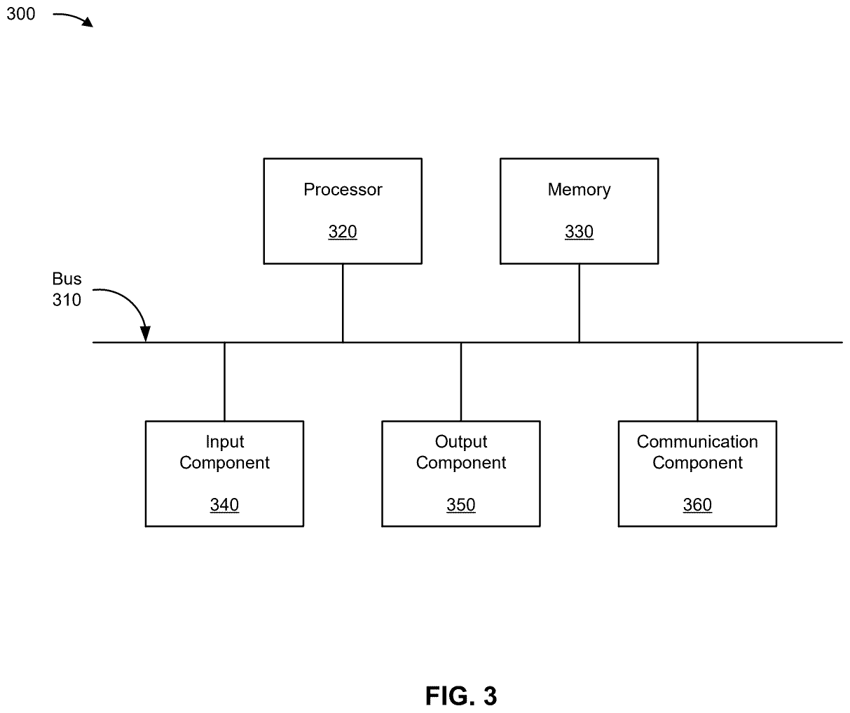

FIGS. 1A-1C are diagrams of an example 100 associated with dynamic and responsive physical communication content and layout generation. As shown in FIGS. 1A-1C, example 100 includes a content device, a data system, and a printer device (e.g., one or more printer devices). These devices are described in more detail in connection with FIGS. 2 and 3. In some implementations, the content device, the data system, and/or the printer device may be components of a higher-level system.

The content device, the data system, and the printer device may be associated with an entity (e.g., a car dealership or other merchant) engaged in the sending of communications to recipients (e.g., customers or potential customers). The communications may include physical communications as well as digital communications. For example, the physical communications may include postal mail (sometimes referred to as “direct mail”), and the digital communications may include website communications, email communications, text message communications, social media communications, and/or point-of-sale (POS) communications (e.g., communications displayed on a transaction terminal interface), among other examples. “Physical communication item,” as used herein, may refer to a postal mail item, but may also refer to another type of physical printed item (e.g., a door hanger, a flyer, a catalog, or the like) in some contexts.

The data system may store interaction data relating to a plurality of recipients. For example, when a recipient of a communication interacts with the communication in some manner, information relating to the interaction may be recorded in the interaction data. As one example, an interaction that may be recorded in the interaction data may include the accessing of a link (e.g., via scanning a QR code) printed on a physical communication item (e.g., a postal mail item). As another example, an interaction that may be recorded in the interaction data may include following a link in a website or an email, viewing a particular web page, requesting information via a web page, or the like. In some implementations, the device (or another device or system) may collect the interaction data, normalize the interaction data, segment the interaction data, or the like, for storage in the data system.

Prior to operations described herein, the plurality of recipients may have received initial physical communication items, which may refer to previous physical communication items and not necessarily chronologically-first physical communication items. In some examples, the initial physical communication items may have identical initial content configurations for each of the recipients. “Content configuration” may refer to the content modules that are used in a physical communication item and the layout in which the content modules are arranged. “Content module” may refer to a predefined unit of one or more images and/or text that are intended to be presented together. A physical communication item may be conceptually divided into one or more panels, and each content module may occupy a respective panel. The layout may indicate the respective panel positions for the content modules, and/or the relative sizes of the panels. Thus, with identical content configurations, the initial physical communication items may have identical content modules arranged in identical layouts. However, variable data, such as the use of personalized names or location-based coupons, may be different across the initial physical communication items.

As an example, for a first recipient (“Amy”), an initial physical communication item may include one or more initial content modules arranged in an initial layout, and for a second recipient (“Bob”), an initial physical communication item may include the same initial content modules arranged in the same initial layout (but the initial physical communication items may differ in that one uses the name “Amy” in a variable data field and the other uses the name “Bob” in a variable data field). In some other examples, the initial physical communication items may include different content modules and/or different layouts for different recipients. For example, for the first recipient, an initial physical communication item may include one or more first initial content modules arranged in a first initial layout, and for the second recipient, an initial physical communication item may include one or more second (e.g., different) initial content modules arranged in a second (e.g., different) initial layout. In some implementations (e.g., if there are no prior physical communication items for the recipients), the different content modules and/or layouts may be based on interaction data associated with the first recipient and the second recipient relating to non-physical-communication channels (e.g., a digital communication channel), such as an email channel, a web channel, a POS channel, a social media channel, a text message channel, and/or a mobile application channel, among other examples.

As shown in FIG. 1A, and by reference number 105, the content device may obtain interaction data relating to the recipients of the initial physical communication items. For example, the content device may obtain the interaction data from the data system (e.g., from one or more databases implemented by the data system). The interaction data relating to the recipients may be segmented in accordance with demographics, purchase history, and/or interaction behavior, among other examples.

The interaction data may include first interaction data indicating interactions of the recipients with the initial physical communication items, and second interaction data indicating interactions of the recipients in one or more non-physical communication channels. For example, for the first recipient, the content device may obtain interaction data that includes first interaction data indicating an interaction of the first recipient with an initial physical communication item (e.g., that has one or more initial content modules arranged in an initial layout), and second interaction data indicating an interaction of the first recipient in a non-physical-communication channel. As described herein, an interaction with a physical communication item may include accessing, with a user device, a personalized link (e.g., a link containing a unique code that identifies a recipient) printed on the physical communication item. For example, the personalized link may be presented on the physical communication item as a uniform resource locator (URL) or a QR code, among other examples. As described herein, an interaction in a non-physical-communication channel may include following a link in a website or an email, viewing a particular web page, or requesting information via a web page, among other examples.

As shown in FIG. 1B, and by reference number 110, the content device may determine respective content configurations for the recipients, which may be used for subsequent physical communication items for the recipients. The content device may determine a content configuration for a recipient based on the interaction data that relates to that recipient (or to a recipient segment to which the recipient belongs). For example, if the interaction data indicates that the recipient is interested in a purchasing a new vehicle (e.g., because the recipient scanned a QR code in an initial physical communication item relating to new vehicle sales, and/or because the recipient registered to receive emails with new vehicle offers), the content configuration may highlight goods and services relating to new vehicles. Conversely, if the interaction data indicates that the recipient is interested selling a used vehicle (e.g., because the recipient scanned a QR code in an initial physical communication item relating to vehicle trade-ins, and/or because the recipient followed a link relating to vehicle market values), the content configuration may highlight goods and services relating to selling a used vehicle.

As an example, for the first recipient, the content device may determine a new content configuration, relative to the initial content configuration, that has a different layout for arranging the initial content modules (e.g., the same content modules may be used but the positions and/or relative sizes in which they appear may be different), or that has one or more new content modules and a new layout for arranging the one or more new content modules. For example, the new content configuration may be personalized for the first recipient, in accordance with the interaction data that relates to the first recipient, and therefore different from a content configuration used for at least one other recipient (e.g., the second recipient), as described below. The new content modules and the initial content modules may differ by at least one content module. A quantity of the new content modules may be the same as a quantity of the initial content modules, or may be different from the quantity of the initial content modules. For example, the new content modules may include fewer content modules than the initial content modules. Similarly, the new layout may differ from the initial layout by a quantity of panels used (e.g., the new layout may have more or fewer panels than the initial layout, which may be a function of the quantity of content modules used), by positions in which content modules, common to the new content modules and the initial content modules, appear, and/or by relative sizes of panels (e.g., one or more panels in the new layout may have different sizes relative to any of the panels in the initial layout).

In the example shown, the initial content configuration for the first recipient may include content modules A, B, C, and D arranged in layout A (e.g., the content modules are arranged in particular positions in one large content panel, one medium content panel, and two equally-sized small content panels). Continuing with the example, the new content configuration for the first recipient may include content modules A, B, and E arranged in layout B (e.g., the content modules are arranged in particular positions in one large content panel and two equally-sized medium content panels).

Moreover, the content configurations determined for different recipients may also have differences. For example, the content device may determine a first content configuration, for the first recipient, having one or more first content modules and a first layout for arranging the one or more first content modules, may determine a second content configuration, for the second recipient, having one or more second content modules and a second layout for arranging the one or more second content modules, and so forth. The first content modules and the second content modules may differ by at least one content module. A quantity of the first content modules may be the same as a quantity of the second content modules, or may be different from the quantity of the second content modules. Similarly, the first layout may differ from the second layout by a quantity of panels used (e.g., the first layout may have more or fewer panels than the second layout, which may be a function of the quantity of content modules used), by positions in which content modules, common to the first content modules and the second content modules, appear, and/or by relative sizes of panels (e.g., one or more panels in the first layout may have different sizes relative to any of the panels in the second layout).

In the example shown, the first content configuration for the first recipient may include content modules A, B, and E arranged in layout B, and the second content configuration for the second recipient may include content modules C, B, A, and D arranged in layout C. Moreover, content module A, which is shared by the first content configuration and the second content configuration, may be in different positions in accordance with the first layout and the second layout. In some implementations, different content configurations may be used for different recipient segments (e.g., rather than individually, at a per-recipient level). For example, recipients in a recipient segment may have similar demographic data, purchase history, and/or interaction behavior, among other examples.

In some implementations, the content device may determine a content configuration using a machine learning model. The machine learning model may be trained to output a content configuration for a recipient based on an input of the interaction data that relates to the recipient (or a recipient segment to which the recipient belongs). For example, the machine learning model may be trained to output the first content configuration for the first recipient based on an input of the interaction data that relates to the first recipient (or a recipient segment to which the first recipient belongs), and to output the second content configuration for the second recipient based on an input of the interaction data that relates to the second recipient (or a recipient segment to which the second recipient belongs).

The machine learning model may be trained using training data that includes historical interaction data relating to numerous individuals. The historical interaction data may relate to interactions with physical communication items and interactions in non-physical-communication channels. In some implementations, the training data may include user profile data relating to the individuals (e.g., demographic information, purchase history, or the like). In some implementations, the feature set for the machine learning model may relate to interaction metrics, such as time between scanning a QR code in a physical communication item and making a related purchase, frequency of page views for different web pages, email link click-through rate, or the like. In some implementations, the machine learning model may be based on a classification algorithm (e.g., a decision tree, a random forest, or a neural network, among other examples), a recommendation system (e.g., based on collaborative filtering, content-based filtering, or a hybrid approach), or a clustering algorithm (e.g., K-means clustering).

As shown by reference number 115, the content device may generate a plurality of electronic documents using the determined content configurations. For example, the content device may generate an electronic document with a responsive rendering of a content configuration. As an example, the content device may generate a first electronic document with a responsive rendering of the content configuration for the first recipient (e.g., a responsive rendering of the one or more content modules of the content configuration in accordance with the layout of the content configuration), and may generate a second electronic document with a responsive rendering of the content configuration for the second recipient (e.g., a responsive rendering of the one or more content modules of the content configuration in accordance with the layout of the content configuration).

A responsive rendering may make adjustments to one or more content modules for adaptation to a particular layout being used. For example, when used with a large content panel of a layout, a particular content module may be rendered using a first set of attributes relating to text and image size and display (as shown with content module A in the first content configuration for the first recipient), but when used with a small content panel of a layout, the same content module may be rendered using a second set of attributes, thereby altering the appearance of the content module (as shown with content module A in the second content configuration for the second recipient). In some implementations, a responsive rendering of a content module may include resizing an image, resizing text, re-arranging a relative layout of an image and text, hiding an image, hiding text, using an alternative version of an image, and/or using an alternative version of text, among other examples. In this way, a single content module can be rendered responsively to adapt to different layouts.

In some implementations, a responsive rendering for an electronic document may use dynamic DOM manipulation of the electronic document. For example, the electronic document may be an HTML document that includes client-side dynamic scripting (e.g., JavaScript) configured for DOM manipulation. DOM manipulation may include modification of DOM elements, such as adding a DOM element, removing a DOM element, and/or modifying an attribute of a DOM element (e.g., a cascading style sheets (CSS) attribute).

In some implementations, when generating an electronic document, the content device may insert personalized content particular to a recipient into one or more content modules. This personalized content may include basic variable data that can be variably inserted into a placeholder field of a content module. For example, the personalized content may include a personalized link for the recipient, a name of the recipient, and/or location-specific content relating to a location of the recipient (e.g., local prices, a location-specific coupon, a city or state name, or the like). The insertion of personalized content may be performed by the content device separately from the responsive rendering of a content configuration (e.g., as two separate operations). For example, the content device may insert personalized content into placeholder fields of one or more content modules, and then the content device may generate an electronic document with responsive rendering of the content modules with the personalized content inserted therein.

In some implementations, the content device may generate electronic documents in real time during a printing run of physical communication items using raster image processing. For example, the content device may generate the first electronic document for the first recipient as a physical communication item for the first recipient is to be printed (e.g., without storing the first electronic document), may then generate the second electronic document for the second recipient as a physical communication item for the second recipient is to be printed (e.g., without storing the second electronic document), and so forth. Alternatively, the content device may generate electronic documents (e.g., one or more batches of electronic documents for multiple recipients) in advance of a printing run, and the content device may store the electronic documents in a fixed format (e.g., an immutable format, such as an image or a portable document format (PDF)). For example, the content device may convert generated HTML documents (e.g., that contain the responsively rendered content modules) into images for storage.

As shown in FIG. 1C, and by reference number 120, the content device may cause printing of physical communication items using the generated electronic documents. For example, the content device may cause variable data printing of physical communication items using the generated electronic documents. To cause the printing of the physical communication items the content device may transmit the electronic documents to the printer device, may store the electronic documents (e.g., in a fixed format) in a printing queue from which the printer device pulls, and/or may transmit a printing instruction to the printer device. In some implementations, the content device may include, or may be included in, the printer device, and the content device, to cause printing of the physical communication items, may perform printing of the physical communication items. Additional subsequent physical communication items may be prepared in a similar manner as described herein, where each subsequent physical communication item for a recipient has a content configuration based on current interaction data associated with the recipient.

The responsive rendering of electronic documents allows robust dynamic content to be added to physical communication items in a fast and efficient manner suitable for extensive VDP runs that otherwise could not be achieved using restrictive, pre-defined templates. Using dynamic content and layouts in physical communication items achieves higher probability of engagement by recipients. Thus, physical communication items using dynamic content and layouts provide a more efficient utilization of computing resources and printer resources (e.g., recipients may engage with such physical communication items at higher rates).

In some implementations, a content configuration used in a digital channel may be dynamically adapted in accordance with a recipient's interaction with a physical communication item. For example, if the recipient accesses a link associated with a first content module of the physical communication item, then the content configuration in a resource (e.g., a web page) referenced by the link may be dynamically adapted to reflect that the user is potentially interested in the first content module. For example, the first content module, or a similar, related content module, may be presented in a primary position of the resource (e.g., at a top of a viewport), and other content modules of the physical communication item may be presented in secondary position(s) of the resource. Similarly, if the recipient were to access a link associated with a second content module of the physical communication item, then the content configuration in a resource (e.g., a web page) referenced by the link may be dynamically adapted to reflect that the user is potentially interested in the second content module. For example, the second content module, or a similar, related content module, may be presented in a primary position of the resource (e.g., at a top of a viewport), and other content modules of the physical communication item (e.g., the first content module) may be presented in secondary position(s) of the resource.

In some implementations, a content configuration determined for a recipient for a physical communication item may also be used for communications in non-physical-communication channels for that recipient. For example, the recipient can also be sent an email communication that uses the same content configuration determined for the physical communication item. In this case, the email communication may include the same content modules as the physical communication item (e.g., which may be in a slightly modified form due to differences in responsive rendering) and may use the same layout as the physical communication item (e.g., the content module that is primarily featured in the physical communication item may be primarily featured in the email communication, the relative sizing of the content modules in the physical communication item may be followed in the email communication, or the like).

As indicated above, FIGS. 1A-1C are provided as an example. Other examples may differ from what is described with regard to FIGS. 1A-1C.

FIG. 2 is a diagram of an example environment 200 in which systems and/or methods described herein may be implemented. As shown in FIG. 2, environment 200 may include a content device 210, a storage system 220, a printer device 230, and a network 240. Devices of environment 200 may interconnect via wired connections, wireless connections, or a combination of wired and wireless connections.

The content device 210 may include one or more devices capable of receiving, generating, storing, processing, providing, and/or routing information associated with dynamic and responsive physical communication content and layout generation, as described elsewhere herein. The content device 210 may include a communication device and/or a computing device. For example, the content device 210 may include a server, such as an application server, a client server, a web server, a database server, a host server, a proxy server, a virtual server (e.g., executing on computing hardware), or a server in a cloud computing system. In some implementations, the content device 210 may include computing hardware used in a cloud computing environment.

The storage system 220 may include one or more devices capable of receiving, generating, storing, processing, and/or providing information associated with dynamic and responsive physical communication content and layout generation, as described elsewhere herein. The storage system 220 may include a communication device and/or a computing device. For example, the storage system 220 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the storage system 220 may store interaction data relating to interactions of recipients with communications, as described elsewhere herein.

The printer device 230 may include one or more devices capable of receiving, generating, storing, processing, and/or printing information associated with physical communication items, as described elsewhere herein. The printer device 230 may include a communication device and/or a computing device. For example, the printer device 230 may include a digital printer, an inkjet printer, a laser printer, or a three-dimensional (3D) printer.

The network 240 may include one or more wired and/or wireless networks. For example, the network 240 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with dynamic and responsive physical communication content and layout generation. The device 300 may correspond to content device 210, storage system 220, and/or printer device 230. In some implementations, content device 210, storage system 220, and/or printer device 230 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

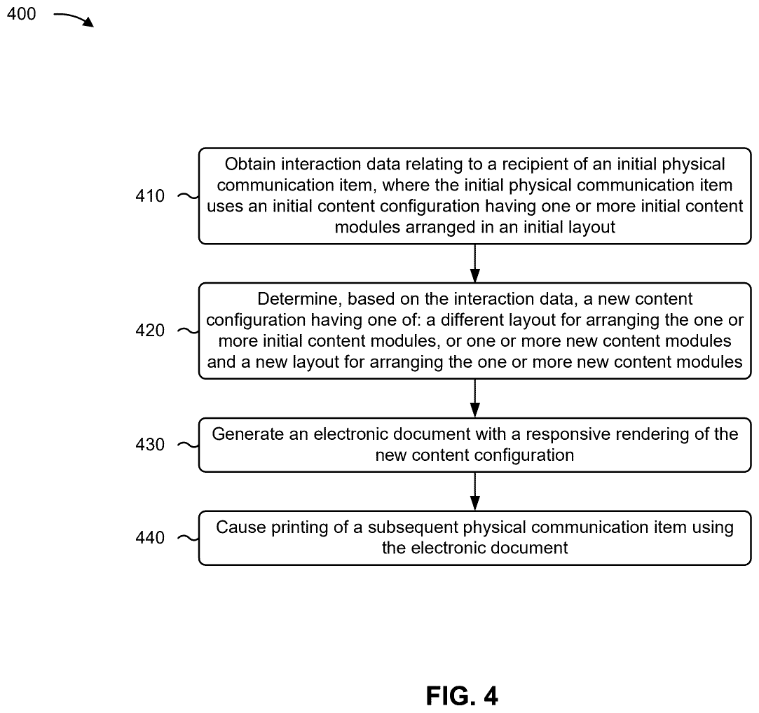

FIG. 4 is a flowchart of an example process 400 associated with dynamic and responsive physical communication content and layout generation. In some implementations, one or more process blocks of FIG. 4 may be performed by the content device 210. In some implementations, one or more process blocks of FIG. 4 may be performed by another device or a group of devices separate from or including the content device 210, such as the storage system 220 and/or the printer device 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining interaction data relating to a recipient of an initial physical communication item, where the initial physical communication item uses an initial content configuration having one or more initial content modules arranged in an initial layout (block 410). For example, the content device 210 (e.g., using processor 320, memory 330, and/or communication component 360) may obtain interaction data relating to a recipient of an initial physical communication item, as described above in connection with reference number 105 of FIG. 1A. As an example, the interaction data may include first interaction data indicating an interaction of the recipient with the initial physical communication item, and second interaction data indicating an interaction of the recipient in a non-physical-communication channel.

As further shown in FIG. 4, process 400 may include determining, based on the interaction data, a new content configuration having one of: a different layout for arranging the one or more initial content modules, or one or more new content modules and a new layout for arranging the one or more new content modules (block 420). For example, the content device 210 (e.g., using processor 320 and/or memory 330) may determine, based on the interaction data, a new content configuration, as described above in connection with reference number 110 of FIG. 1B. As an example, the new content configuration may be personalized for the recipient, in accordance with the interaction data that relates to the recipient, and therefore different from a content configuration used for at least one other recipient.

As further shown in FIG. 4, process 400 may include generating an electronic document with a responsive rendering of the new content configuration (block 430). For example, the content device 210 (e.g., using processor 320 and/or memory 330) may generate an electronic document with a responsive rendering of the new content configuration, as described above in connection with reference number 115 of FIG. 1B. As an example, the responsive rendering may use dynamic DOM manipulation of the electronic document, such as adding a DOM element, removing a DOM element, and/or modifying an attribute of a DOM element.

As further shown in FIG. 4, process 400 may include causing printing of a subsequent physical communication item using the electronic document (block 440). For example, the content device 210 (e.g., using processor 320, memory 330, output component 350, and/or communication component 360) may cause printing of a subsequent physical communication item using the electronic document, as described above in connection with reference number 120 of FIG. 1C. As an example, the printing may utilize variable data printing using the generated electronic document.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1C. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for dynamic and responsive physical communication content and layout generation, the system comprising:
one or more memories; and
one or more processors, communicatively coupled to the one or more memories, configured to:
obtain interaction data relating to a plurality of recipients of physical communication items,
wherein the interaction data includes first interaction data indicating interactions of the plurality of recipients with the physical communication items, and second interaction data indicating interactions of the plurality of recipients in one or more non-physical-communication channels;
determine respective content configurations for the plurality of recipients, wherein the respective content configurations include:
a first content configuration, for a first recipient of the plurality of recipients, having one or more first content modules and a first layout for arranging the one or more first content modules based on the interaction data that relates to the first recipient, and
a second content configuration, for a second recipient of the plurality of recipients, having one or more second content modules and a second layout for arranging the one or more second content modules based on the interaction data that relates to the second recipient;
generate a plurality of electronic documents including a first electronic document with a responsive rendering of the first content configuration and a second electronic document with a responsive rendering of the second content configuration; and
cause variable data printing of a plurality of physical communication items using the plurality of electronic documents.

2. The system of claim 1, wherein the one or more processors, to determine the first content configuration and the second content configuration, are configured to:
determine the first content configuration and the second content configuration using a machine learning model,
wherein the machine learning model is trained to output the first content configuration based on an input of the interaction data that relates to the first recipient, and to output the second content configuration based on an input of the interaction data that relates to the second recipient.

3. The system of claim 1, wherein the one or more processors, to generate the plurality of electronic documents, are configured to generate the plurality of electronic documents in real time during a printing run using raster image processing.

4. The system of claim 1, wherein the one or more processors, to generate the plurality of electronic documents, are configured to:
generate the plurality of electronic documents in advance of a printing run; and
store the plurality of electronic documents in a fixed format.

5. The system of claim 1, wherein the responsive rendering of the first content configuration or the responsive rendering of the second content configuration uses dynamic document object model manipulation.

6. The system of claim 1, wherein the plurality of electronic documents are hypertext markup language (HTML) documents that include client-side dynamic scripting configured for document object model manipulation.

7. The system of claim 1, wherein the responsive rendering of the first content configuration or the responsive rendering of the second content configuration includes one or more of:
resizing an image,
resizing text,
re-arranging a relative layout of an image and text,
hiding an image,
hiding text,
using an alternative version of an image, or
using an alternative version of text.

8. The system of claim 1, wherein the responsive rendering of the first content configuration is a responsive rendering of each of the one or more first content modules in accordance with the first layout, and
wherein the responsive rendering of the second content configuration is a responsive rendering of each of the one or more second content modules in accordance with the second layout.

9. The system of claim 1, wherein the one or more non-physical-communication channels include one or more of:
an email channel,
a web channel,
a point-of-sale channel,
a text message channel, or
a mobile application channel.

10. A method of dynamic and responsive physical communication content and layout generation, comprising:
obtaining interaction data relating to a recipient of an initial physical communication item,
wherein the interaction data includes first interaction data indicating an interaction of the recipient with the initial physical communication item, and second interaction data indicating an interaction of the recipient in a non-physical-communication channel, and
wherein the initial physical communication item uses an initial content configuration having one or more initial content modules arranged in an initial layout;
determining, based on the interaction data, a new content configuration having one of:
a different layout for arranging the one or more initial content modules, or one or more new content modules and a new layout for arranging the one or more new content modules;
generating an electronic document with a responsive rendering of the new content configuration; and
causing printing of a subsequent physical communication item using the electronic document.

11. The method of claim 10, wherein the new content configuration is personalized to the recipient in accordance with the interaction data, and different from a content configuration used for at least one other recipient of a physical communication item.

12. The method of claim 10, wherein the interaction of the recipient with the initial physical communication item includes accessing, with a user device, a personalized link printed on the initial physical communication item.

13. The method of claim 10, wherein generating the electronic document comprises:
inserting personalized content particular to the recipient into one or more content modules,
wherein the personalized content includes one or more of a personalized link for the recipient, a name of the recipient, or location-specific content relating to a location of the recipient.

14. The method of claim 10, wherein the responsive rendering of the new content configuration uses dynamic document object model manipulation.

15. The method of claim 10, wherein the electronic document is a hypertext markup language (HTML) document that includes client-side dynamic scripting configured for document object model manipulation.

16. The method of claim 10, wherein the responsive rendering of the new content configuration includes one or more of:
resizing an image,
resizing text,
re-arranging a relative layout of an image and text,
hiding an image,
hiding text,
using an alternative version of an image, or
using an alternative version of text.

17. A non-transitory computer-readable medium storing a set of instructions for dynamic and responsive physical communication content and layout generation, the set of instructions comprising:
one or more instructions that, when executed by one or more processors of a device, cause the device to:
obtain interaction data relating to a recipient of an initial physical communication item,
wherein the interaction data indicates an interaction of the recipient with the initial physical communication item, and
wherein the initial physical communication item uses an initial content configuration having one or more initial content modules arranged in an initial layout;
generate an electronic document with a responsive rendering of a new content configuration, wherein the new content configuration has one of:
a different layout for arranging the one or more initial content modules, or
one or more new content modules and a new layout for arranging the one or more new content modules; and
cause printing of a subsequent physical communication item using the electronic document.

18. The non-transitory computer-readable medium of claim 17, wherein the responsive rendering of the new content configuration uses dynamic document object model manipulation.

19. The non-transitory computer-readable medium of claim 17, wherein the electronic document is a hypertext markup language (HTML) document that includes client-side dynamic scripting configured for document object model manipulation.

20. The non-transitory computer-readable medium of claim 17, wherein the responsive rendering of the new content configuration includes one or more of:
resizing an image,
resizing text,
re-arranging a relative layout of an image and text,
hiding an image, or
hiding text.
